(19) United States
(12) Patent Application Publication
(10) Pub. No.: US 2020/0029731 A1
(43) Pub. Date: Jan. 30, 2020

(54) MULTI-FUNCTION COOKING OVEN HAVING HORIZONTALLY AND VERTICALLY ORIENTED COOKING ELEMENTS AND MULTI-POSITION HORIZONTAL AND VERTICAL ROTATION DEVICES

(71) Applicant: RONCO HOLDINGS INC., Austin, TX (US)

(72) Inventor: Ron HUNT, GEORGETOWN, TX (US)

(73) Assignee: RONCO HOLDINGS INC., AUSTIN, TX (US)

(21) Appl. No.: 15/923,627

(22) Filed: Mar. 16, 2018

Related U.S. Application Data
(60) Provisional application No. 62/472,553, filed on Mar. 16, 2017.

(51) Int. Cl. A47J 37/04; A47J 27/00; A47J 37/06

(52) U.S. Cl. CPC A47J 37/041; A47J 37/0641; A47J 27/002

(57) ABSTRACT

Aspects of the present disclosure are directed to a multi-function cooking oven having horizontally and vertically oriented heating elements and cooking functions that configure horizontal and vertical position, horizontal and vertical rotation, radiation and superheated air circulation for cooking food within the oven enclosure. Cooking functions include horizontal rotisserie, vertical rotisserie, baking, warming, dehydrating, pizza, barbecuing, kebabs, toasting, boiling, and air frying. Depending on the cooking function, a timer is set for turning on and off the horizontally and vertically oriented heating elements and a fan providing heated airflow within the oven enclosure. The timer also controls rotation of a vertical axis turntable assembly and a horizontal spit assembly configured with or without a wire drum. In an air fryer function configuration, a wire cage containing food is mounted in close proximity to the vertically oriented heating element on the back wall of the oven enclosure vertically oriented heating element and rotated to bring the food into a superheated region of the oven close to the vertically oriented heating element. Operating in a baking function, the turntable assembly is mounted within in a bottom slot of the oven with its mechanical gear linkage set in a first position to engage a motor for vertical axis rotation of the baked goods. When operating in a pizza cooking function, the vertical axis turntable assembly is mounted within a slot in the middle of the oven enclosure with its gear linkage rotated into a second position to engage the motor for vertical axis rotation of the turntable.

### CROSS REFERENCE TO RELATED APPLICATIONS

This application claims the benefit of U.S. Provisional Patent Application Ser. No. 62/472,553 filed Mar. 16, 2017 which is incorporated by reference as if set forth at length herein.

### TECHNICAL FIELD

This disclosure relates generally to the field of food cooking apparatus. More specifically, this disclosure relates to devices to bake and cook foods, and more particularly to food cooking ovens that use food movement, radiant energy, and heat energy to bake and cook food products.

### BACKGROUND

Specialty indoor cooking ovens are in wide use in the United States. Air Fryers, dehydrators, horizontal rotisseries, vertical rotisseries, convection ovens, toaster ovens, and baking ovens are some of the products that compete for limited space on the kitchen counter. Most of these food cooking devices use hot electrical elements to radiantly warm, cook or dehydrate foods such as meats, fish, foul, vegetables and baking goods. It would be desirable to have a single device which could cook a variety of foods and avoid the cost and counter/storage space required to have many specialty ovens to perform these various cooking techniques.

### SUMMARY

An advance in the art is made according to aspects of the present disclosure directed to a multi-function cooking oven having horizontally and vertically oriented heating elements and cooking functions that configure horizontal and vertical position, horizontal and vertical rotation, radiation and superheated air circulation for cooking food within the oven enclosure. Cooking functions include horizontal rotisserie, vertical rotisserie, baking, warming, dehydrating, pizza, barbecuing, kebabs, toasting, boiling, and air frying. Depending on the cooking function, a timer is set for turning on and off the horizontally and vertically oriented heating elements and a fan providing heated airflow within the oven enclosure. The timer also controls rotation of a vertical axis turntable assembly and a horizontal spit assembly configured with or without a wire drum. In an air fryer function configuration, a wire cage containing food is mounted in close proximity to the vertically oriented heating element on the back wall of the oven enclosure vertically oriented heating element and rotated to bring the food into a superheated region of the oven close to the vertically oriented heating element. Operating in a baking function, the turntable assembly is mounted within in a bottom slot of the oven with its mechanical gear linkage set in a first position to engage a motor for vertical axis rotation of the baked goods. When operating in a pizza cooking function, the vertical axis turntable assembly is mounted within a slot in the middle of the oven enclosure with its gear linkage rotated into a second position to engage the motor for vertical axis rotation of the turntable.

### BRIEF DESCRIPTION OF THE DRAWING

A more complete understanding of the present disclosure may be realized by reference to the accompanying drawing in which:

FIG. 1 is perspective view of an illustrative multi-function cooking oven according to aspects of the present disclosure;

FIG. 2 is a side view of an illustrative multi-function cooking oven according to aspects of the present disclosure;

FIG. 3 is an exploded view of illustrative driving mechanism for an illustrative multi-function cooking oven according to aspects of the present disclosure;

FIG. 4 shows an interior of an illustrative multi-function cooking oven according to aspects of the present disclosure;

FIG. 5 shows a side view of an illustrative multi-function cooking oven according to aspects of the present disclosure;

FIG. 6 is a front view of an illustrative multi-function cooking oven showing convection currents according to aspects of the present disclosure;

FIG. 7 is a side view of an illustrative multi-function cooking oven showing airflow according to aspects of the present disclosure;

FIG. 8 is perspective view of a rotisserie spit assembly for an illustrative multifunction cooking oven according to aspects of the present disclosure;

FIG. 9 is a front view of a cooking oven according to aspects of the present disclosure;

FIG. 10 is an exploded view of a rotisserie and driving assembly for an illustrative multi-function cooking oven according to aspects of the present disclosure;

FIG. 11 is a side view of driving gears for an illustrative multi-function cooking oven according to aspects of the present disclosure;

FIG. 12 is a perspective view of internal components of an illustrative multifunction cooking oven according to aspects of the present disclosure;

FIG. 13 is a perspective view of a rotisserie, heating element and driving assembly for an illustrative multi-function cooking oven according to aspects of the present disclosure;

FIG. 14(A) and FIG. 14(B) are front views of a rotisserie positioned at different levels respectively, heating element and driving assembly for an illustrative multi-function cooking oven according to aspects of the present disclosure;

FIG. 15 is a perspective view of a turntable assembly and driving mechanism for an illustrative multi-function cooking oven according to aspects of the present disclosure;

FIG. 16 is a side view of a turntable assembly and driving mechanism for an illustrative multi-function cooking oven according to aspects of the present disclosure;

FIG. 17 is a side view of a turntable assembly and driving mechanism for an illustrative multi-function cooking oven according to aspects of the present disclosure;

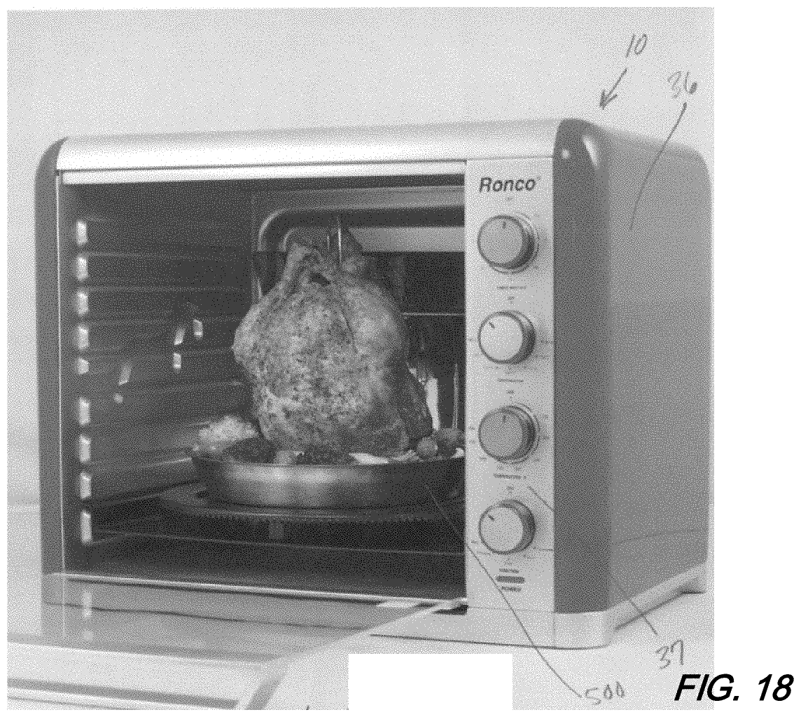

FIG. 18 is a perspective interior view of an illustrative multi-function cooking oven according to aspects of the present disclosure;

FIG. 19 is a schematic side view of an air fryer assembly for an illustrative multifunction cooking oven according to aspects of the present disclosure;

FIG. 20 is a perspective front interior view showing an air fryer assembly of an illustrative multi-function cooking oven according to aspects of the present disclosure;

FIG. 21 is a perspective front view showing a dehydrator assembly of an illustrative multi-function cooking oven according to aspects of the present disclosure;

FIG. 22 is a perspective interior view of an illustrative multi-function cooking oven according to aspects of the present disclosure;

FIG. 23 is a front interior view showing a toast function and assembly of an illustrative multi-function cooking oven according to aspects of the present disclosure; and

FIG. 24 is a front interior view showing a warm function of an illustrative multifunction cooking oven according to aspects of the present disclosure;

FIG. 25 and FIG. 26 is a front interior view showing a bake and broil function, respectively, of an illustrative multifunction cooking oven according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Unless otherwise explicitly specified herein, the FIGs comprising the drawing are not drawn to scale.

We begin by noting that while one or more embodiments may be susceptible to various modifications and alternative forms, specific embodiments thereof are shown by way of illustrative example in the drawings and will herein be described in detail. It should be understood, however, that the drawings and detailed description thereto are not intended to limit the disclosure to the form disclosed, but on the contrary, the disclosure is to cover all modifications, equivalents and alternatives falling within the spirit and scope of this disclosure.

In one or more embodiments, a multi-function cooking apparatus is provided. For example, the multi-function cooking apparatus can be implemented as a multi-function oven to cook and bake a variety of foods, and more particularly to cook and bake a variety of foods using a variety of cooking techniques, functions and cooking sources. For instance, a multi-function food cooking oven is described that uses food movement, radiant energy, and heat energy to bake and cook food products. In one or more embodiments, multi-function cooking apparatus is an oven configured to provide ten or more cooking functions, including baking, pizza cooking, horizontal rotisserie, vertical rotisserie, air fryer, toaster, dehydrator, barbecue, broiler and warmer.

In one or more embodiments, an indoor use food cooking oven has multiple functions and is configured for multiple methods of cooking. For example, the food cooking oven rotates cooking foods about either a horizontal or vertical axis. The food cooking oven also provides a strong superheated air flow fan design and multiple vertically spaced storage racks for cooking, dehydrating and baking at various rates and temperatures. For instance, the food cooking oven can bake pastries and dehydrate fruits and jerky.

Still further, in one or more embodiments, there is provided a food cooking oven multiple functions in a compact unit. The multi-function cooking oven comprises a housing defining an interior chamber, the housing including a glass door opening adapted to receive a food product into the interior chamber. Preferably, the housing includes means adapted for receiving a drip pan therein, which drip pan is oriented so as to receive drippings from food disposed in the interior chamber while being heated by a heating element.

In one or more embodiments, the food cooking oven is adapted for securing, within the interior chamber, multiple rotatable members to a common mechanical coupling so as to be linked therewith such that mechanical energy from a motor is transferred to the rotatable members through the mechanical coupling. In some preferred embodiments, a rotatable ten tooth motorgear can be configured to drive one or more of a horizontal rotisserie, vertical rotisserie, air fryer drum, kabobs, a rotating pizza pan and a turntable for moving food associated therewith relative to the electrical resistance element when disposed in the interior chamber.

In one preferred embodiment, a control panel allows control often separate cooking functions with the multi-function cooking oven, including a settable timer adapted for selectively activating at least one of the rotatable members from among the group consisting of the vertical turntable or horizontal the history rotisserie and air fryer drums and also the 3 or more heating elements for a selected duration based on the cooking function. In addition, the oven includes a lighting element adapted to project light into the interior chamber when the oven is on.

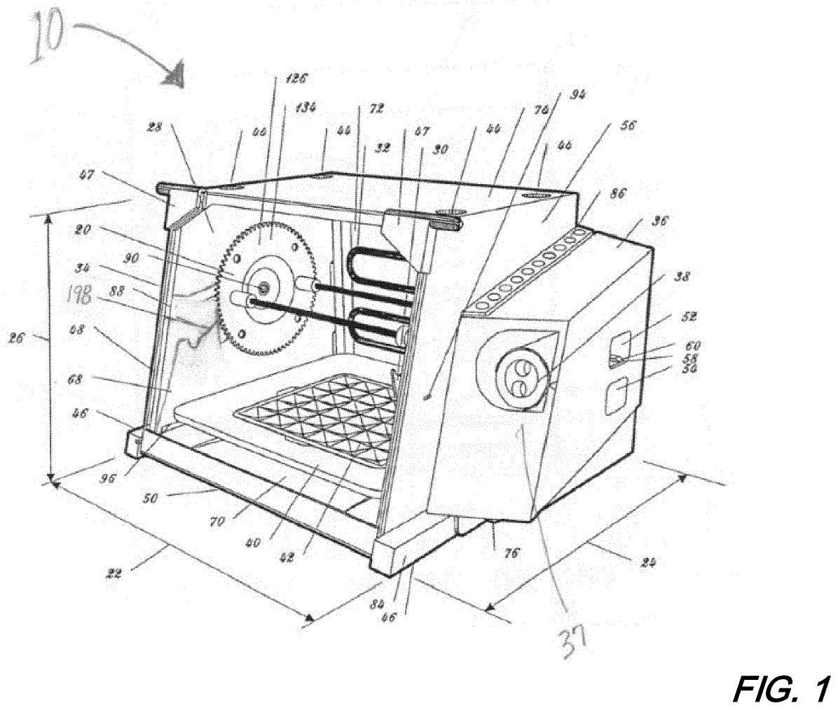

Turning now to FIG. 1, there is depicted a perspective view of a multi-function cooking oven of one or more preferred embodiments. The multi-function cooking oven 10 of preferred embodiments has a metal enclosure generally comprised of an essentially horizontal metal floor 70 and metal roof 74, a generally vertical metal back 72, and two essentially vertical side walls, left oven wall 68 and right oven wall 56, and a glass door 34. The right vertical oven wall side 56 extends out to include room for a front control panel 37 behind which is an enclosure 36 with room for a large fan and a synchronous drive motor. Oven cavity 28 provides adequate interior space for cooking on a horizontal spit such popular foods such as: turkeys, chickens, roast beef, leg of lamb, and other common foods. It also allows a vertical axis turntable within the oven cavity which is sufficiently large to cook such foods as: beer can chicken, pizzas, cookies, hors d'oeuvres, and other popular food items.

Left oven wall 68, right oven wall 56, roof 74, floor 70, and back wall 72 may be of a single or multiple ply and may be constructed of any appropriate material. As examples, they may be constructed from steel or aluminum or other metal or other materials such as high temperature plastics; any of which mayor may not be coated with such materials as: electroplated metal, nonstick coating, paints or other finishes. They may also be fabricated using any appropriate method. As examples, they may be: stamped, drawn, molded, pressure formed, or otherwise constructed. Alternative construction techniques to those taught herein are well-known in the art and thus are not described in this document.

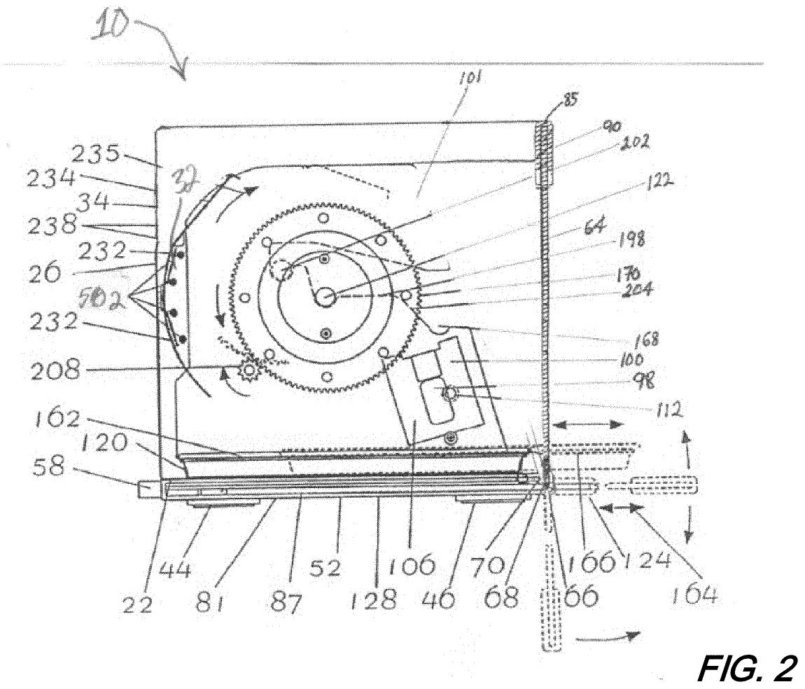

In operation, door 34 is lowered and slid beneath the unit as shown in FIG. 2 to FIG. 5 described in more detail below. The door is also suitably removed for cleaning. Rails 46 provide support for the embodiment on a countertop as well as provide tracks to slide door 34 beneath oven cavity 28. Rails 46, by spacing oven cavity 28 off a countertop, help prevent excessive heat from reaching such a countertop. Door handle 47 provides a cool, easy to grasp handle for raising and lowering door 34. The door handle also provide protection against breakage for glass panel 48 which comprises most of door 34. The door handle is suitably comprised of PBS or other high temperature plastic. Glass panels, including tempered glass panels, are most vulnerable to breakage when impacted on their corners or edges. Likewise, pivot pin 50 runs along the bottom of glass panel 48 and protrudes beyond both its lower corners, to provide similar protections as door handle 47. Drip pan 40 is covered by drip pan cover 42, and in combination they function to catch grease and oils dripped from cooking foods. Drip pan cover 42 also functions to prevent fires which might occur by limiting the amount of oxygen that can reach fats and oils contained within drip pan 40.

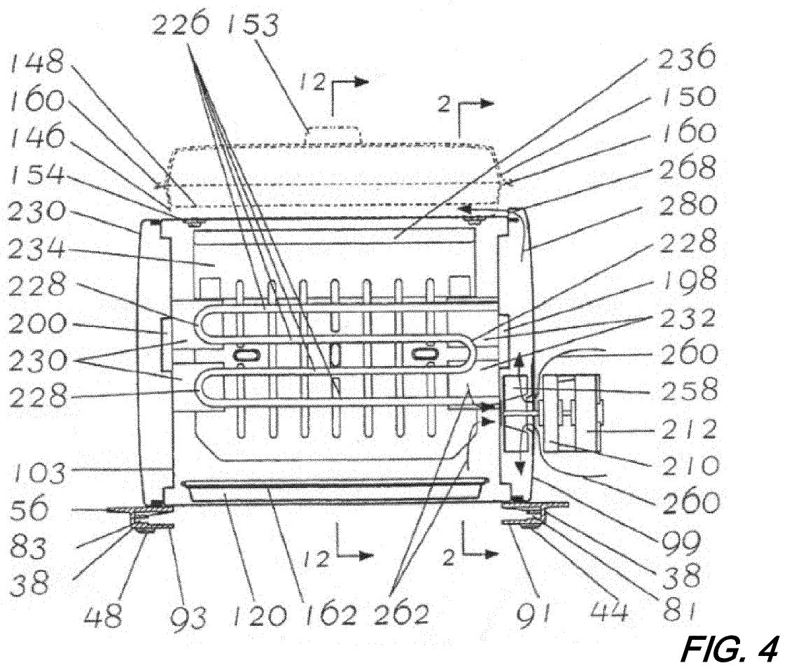

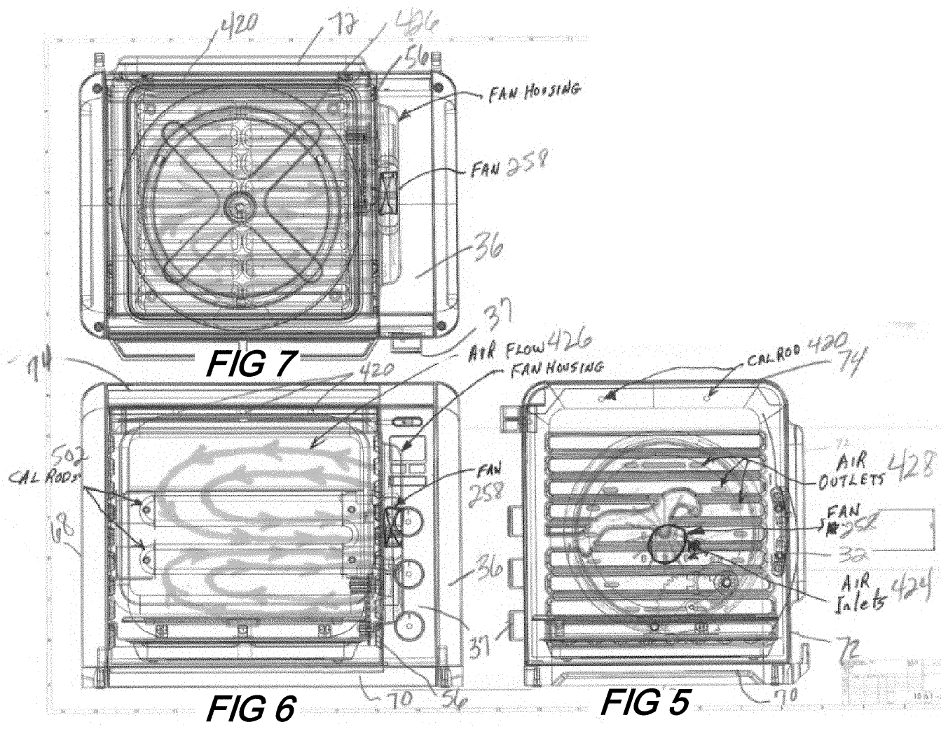

As most clearly shown in FIG. 4, directly adjacent to, and approximately halfway up the back 72 is heating element 32, which in one preferred embodiment is a serpentine shaped electric heat coil having heating rods 502. This heating element 32 winds back and forth across the back 26 of the enclosure 20 creating four straight heat rods 502 terminated by three “U” turns 228 and two rods passing through the enclosure's right side interior wall. The coil is supported on its right and left ends by support brackets 230 and 232 which slide over the “U” turns 228 in the coil and position it to allow for expansion and contraction as the coil heats and cools, while maintaining the coil's correct position. There are two additional heating elements 420 (shown in FIG. 5), each substantially identical to heating element 32, within oven cavity 28 near the top of the inside of the multi-function cooking oven 10 near metal roof 74 that extends from the left oven wall 68 to the right oven wall 56.

Spit assembly 170 is suspended horizontally within oven cavity 28 by spit supports 198. Heating element 32 provides the heat to cook foods within the oven cavity 28. Two additional Spit supports 30 have forward rest positions 168 which provide the user an easy place to set down spit assembly 20 before sliding it into cooking position 122. Spit supports 30 as well as heater support 66 are attached to oven cavity 28 walls by tabs 92 on the supports sliding into slots 94 located on the walls. The right-side control panel 37 contains digital countdown timer 38 which turns off operation of the unit by any suitable means at a time preset by the user.

Horizontal Rotisserie Function

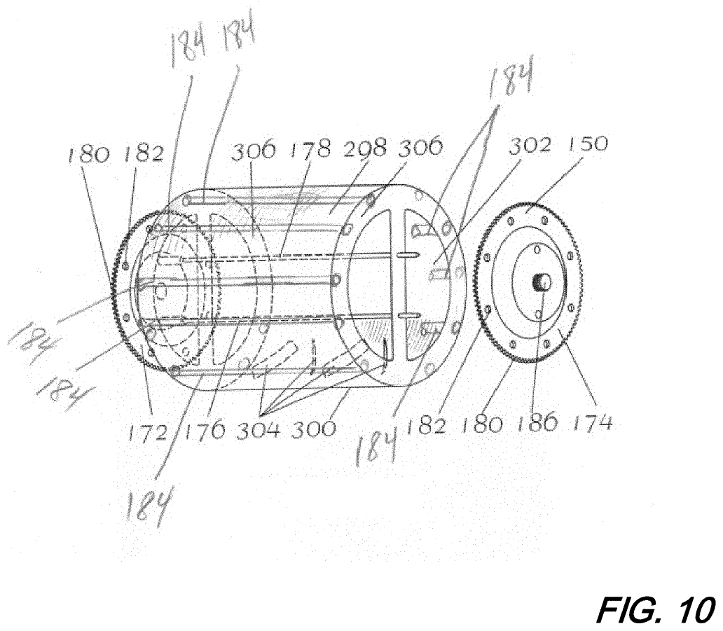

As shown in FIG. 8, the horizontal rotisserie function's spit assembly 170 comprises a first metal spit plate 172 and a second metal spit plate 174. The first metal spit plate 172 has two sharpened cylindrical spit rods 176, 178 attached at right angles to it. This first metal spit plate 172 is circular in outline with gear teeth 180 on its periphery and eight evenly spaced essentially round kabob holes 182 penetrating it just inside of and adjacent to the gear teeth 180. These kabob holes 182 are for supporting kabob rods 184 as explained later. The center of the first metal plate 172 is frustum conically indented away from the projecting attached spit rods with a stub axle 186 projecting from the back-bottom center of the plate's 172 frustum conical indent. The stub axle 186 has circular grooves 188 cut into its cylindrical periphery. These grooves 188 help to prevent squeaking from the stub axles rubbing against their support tracks 198 and 200, described later, when the spit assembly 170 is rotating.

The second metal spit plate 174 is the mirror image of the first metal spit plate 172 except in place of the two attached spit rods 176 and 178 it has two short spit rod support tubes 192 attached. These tubes 192 receive, and hold by an overlapping friction fit, the sharpened ends of the two spit rods 176 and 178.

Foods are secured to the spit simply by running one or both of the two sharpened spit rods 176 and 178 through the food and then capping the rods by pushing the tubes 192 in the second spit plate 174 over the sharpened ends of the spit rods 176 and 178 projecting from the first spit plate 172. The food is then easily inserted into the embodiment as explained later.

The spit assembly 170 has several advantages over other available spit assemblies. It is compact and efficient in the use of space both inside and outside the cooking cavity 28. Because the spit assembly 170 is placed straight into the cooking cavity 28 without angling or sliding into a drive socket, and because no drive forks or other space robbing mechanisms are required to hold even large and heavy pieces of food, almost the entire length of the spit rods 176 and 178, which run almost the full width of the cooking cavity 28 from the interior left oven wall 103 to the interior right oven wall 101, may be used to cook food. Other available spit rods, because they must be angled into place and slid into a drive socket are far less efficient in cooking space utilization.

Also, with the spit rods 176 and 178 of one or more preferred embodiments there is no loss of space outside the cooking cavity 28 while foods are being loaded into or are being cooked in the cooking cavity 28. Other available spit rods have handles which project beyond their cooking enclosure and waste valuable counter space.

The spit assembly 170 with its dual spit rod 176 and 178 design, holds foods more firmly than other single spit rod designs. This advantage means that even heavy and large foods rotate solidly with the spit assembly 170 and don't become loose and flop or fall off the rods 176 and 178. On other spit rod designs, foods tend to shift while rotating and become loose and fall off the spit rods when this looseness bores a hole through the food being cooked.

The spit assembly 170 also integrates the mounting of self-rotating kabob rods into its design. Many other spit rod designs don't even plan for the mounting of non-rotating kabob rods. And the spit assembly 170 also allows for the easy and solid mounting of other cooking accessories such as cooking baskets 270. Other spit rods designs may make no such provisions.

The spit assembly 170 of one or more preferred embodiments makes food mounting easy. The food is simply pushed onto the two relatively skinny and sharp spit rods 176 and 178, the second spit plate 174 slid into place, and the assembly, food and all, is placed directly into the cooking cavity 28. Other designs have thicker spit rods which are more difficult to shove through foods, and these designs may require hard to use accessories, such as mounting forks, to secure the foods from rotating independently of the spit while cooking and placing foods into their cooking enclosures is more difficult, as explained in the next paragraph.

The spit assembly 170 of one or more preferred embodiments is easy and intuitive to load into the cooking cavity 28. The assembly 170 is simply shoved directly into the cooking cavity without angling or having to align its end with and slide it into a drive socket. Other designs with drive sockets or other complicated drive means are far more difficult to use.

And foods are easy to unload from the preferred embodiment's spit assembly 170. The assembly 170 will simply slide straight out of the cooking cavity 28, the second spit plate 174 easily removed, and the foods slid off the two rods 176 and 178. Other spit rods are difficult to remove from their cooking enclosures, some requiring the attachment of handles or lifting devices, and/or angling to uncouple drive mechanisms, and may require the additional steps of removal of accessories, such as food mounting forks. The spit assembly 170 of one or more preferred embodiments may be mounted closer to the cooking heat source 110 to speed cooking of smaller foods. Other spit rod designs don't offer this feature.

Cleaning of the spit rods 176 and 178 is enhanced by nonstick coating, like that used in nonstick fry pans, covering their surfaces which contact food during cooking. The ends of the spit rods may be left uncoated to facilitate the easy insertion of the rods 176 and 178 into the spit rod support tubes 192.

Because there are two spit rods 176 and 178, foods may be penetrated by both rods 176 and 178 and thus the foods may be securely held and prevented from spinning independent of the spit assembly's 170 rotation or prevented from dropping off the spit assembly 170. This compares to conventional single rod spit designs which tear holes in food because all the food's weight is supported on a single rod. Foods supported on such single rods may break loose and fail to turn as the spit turns because of inadequate torsional support engagement between the spit and the food. Foods may also fall off single spit rods due to inadequate weight distribution and support, and because food movement not synchronized with the spit tends to tear holes in the foods which results in the foods tearing loose of the spit.

Once the spit 170 is fully assembled with the food skewered on the spit rods 176 and 178 and the tubes 192 projecting from the second metal spit plate slid over and capping the pointed ends of the spit rods 176 and 178 orthogonally projecting from the first metal spit plate 172, the spit assembly 170 is ready to be loaded into the enclosure.

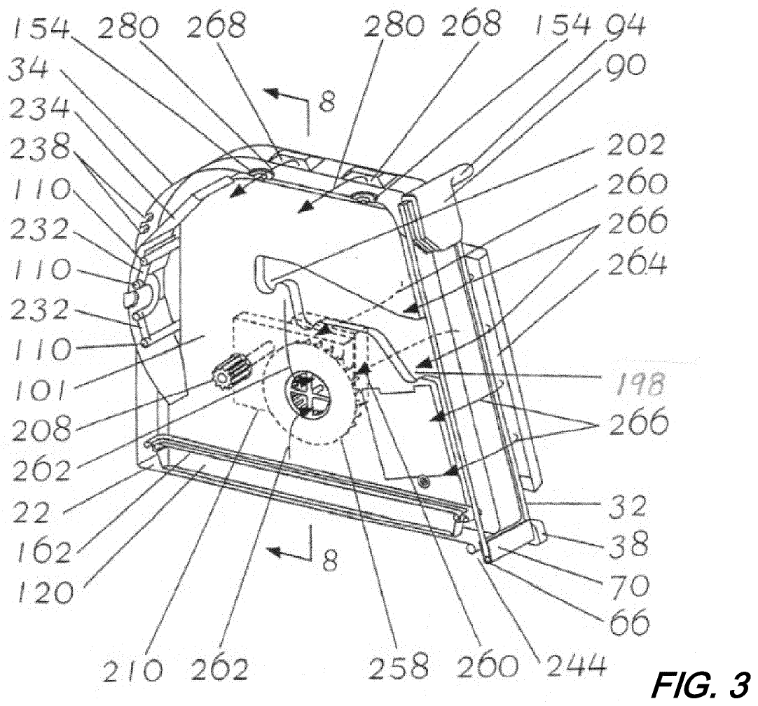

As seen in FIG. 1, FIG. 2 and FIG. 3, the double paneled right-side wall 28 and the double paneled left side wall 30 each contain an indented spit support track 198, 200 on their interior panels 101 and 103. In one preferred embodiment, the spit support track 200 on the interior panel 103 of the left double paneled side wall 30 is a mirror image of the spit support track 198 on the interior panel 101 of the right double paneled side wall 28.

These two spit support tracks 198 and 200 engage the stub axles 186 on the spit plates 172 and 174 when the spit assembly 170 is slid into the enclosure 20. The tracks 198 and 200 allow the spit assembly 170, including any spit accessories or any food thereon, to slide in and out of the enclosure 20. In addition, each track 198 and 200 has three axle positioning indents 168, 122 and 202 which can support and hold the stub axles 186, and thus the spit assembly 170. In specific track 198, 200 locations, stub axles 186 can be engaged by gravity into axle positioning indent positions 168, 122 and 202 and permits rotation of spit assembly 170 therein.

The first axle positioning indent position 168 of these axle positioning indents positions 168, 122 and 202 is located on each track 198 and 200 adjacent to the door 32 opening. This axle positioning indent position 168 is referred to as the rest position and has several functions. First, when loading or unloading food from the embodiment, it may be first rested in this axle positioning indent position 168 where a better grip may be obtained on the food or where it simply may be rested. It also serves as the first location to catch the spit assembly 170 as it is being loaded into the embodiment, and the last location to catch the spit assembly 170 before it leaves. It also serves as an area to prepare food. As an example, in the rest axle positioning indent position 168 foods can be centered on the spit rod, or ties to secure the wings and legs on a chicken might be readjusted, or barbecue sauce can be brushed on a chicken or baby back ribs, or seasonings applied to other foods.

When the rest axle positioning indent position 168 is being used for food preparation, it may be advantageous to pull the drip pan 120 and attached grate cover 162 to their part way out position 166, as explained earlier, to keep foods and preparations from dripping or dropping onto the countertop or glass door.

The rest axle positioning indent position 168 on each spit support track 198 and 200 is backed by an upwardly inclined track portion 204. This inclined track 204, combined with the large open front throat of the track and rest axle positioning indent position 168, makes it easy to catch the spit assembly 170 and hold it in the rest axle positioning indent position 168 when it is inserted into the enclosure 20, and it makes it obvious that the spit assembly 170 has been caught in the rest axle positioning indent position 168 when it is being removed from the enclosure 20.

When the spit assembly 170 is being loaded into the enclosure 20, the assembly 170 first passes the rest axle positioning indent position 168, then the inclined track portion 204, and next it comes to the low heat axle positioning indent position 122. In the low heat axle positioning indent position 122 the gear teeth 180 on the perimeter of the spit plate closest to the right side inner side wall 101 engage a motor driven drive gear 208 which penetrates the enclosure through the right side inner side wall 101. The spit assembly 170 and any spit accessories or food thereon, may be rotated by this motor driven drive gear 208 in front of rear heating element 32.

Rotisserie cooking in the preferred embodiment differs in several ways from conventional oven cooking. First, in conventional oven cooking the food remains stationary and is cooked by hot air. In the preferred embodiment, food is rotated about a horizontal axis and is cooked by a combination of both radiant energy coming directly from the heating element 32 and air heated by the heating elements 32, 420. Radiant energy is generally more efficient than hot air in conveying cooking energy to food and thus typically gets foods hotter quicker. However, without food rotation, radiant energy tends to dry out and burn foods as is the case in most conventional oven broilers. Also, without food rotation, radiant energy tends to cook grease and oil into foods, and particularly into meats.

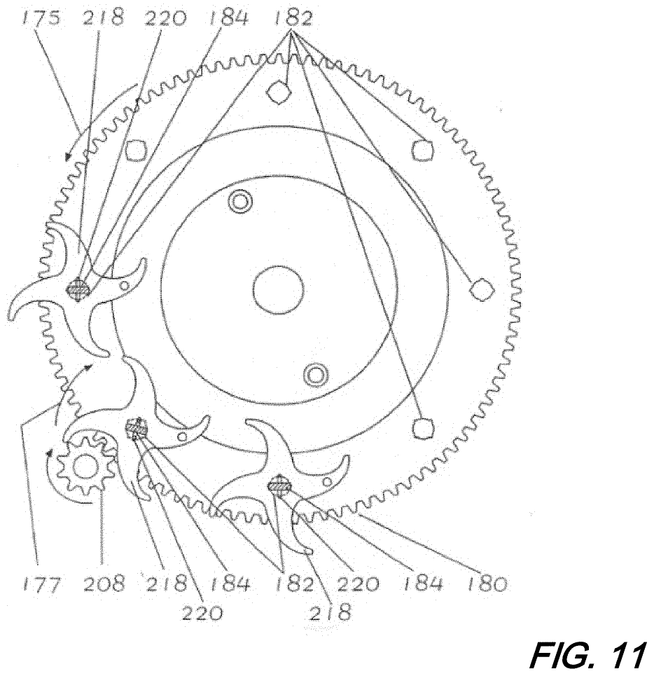

FIG. 9 is an image of multi-function cooking oven 10 operating in the horizontal rotisserie function. As depicted, a ham is mounted on spit 130 and being cooked in the horizontal rotisserie function mode of control panel 37. In that mode, control panel 37 engages motor 524 to rotate spit 130, turns on heating elements 32 and/or 420 and sets a timer in enclosure 36 for the cooking of food in the horizontal rotisserie function mode.

Rotisserie cooking in the preferred embodiment is generally quicker than conventional oven cooking. This is partly due to the efficiency of radiant energy heating and due to food movement, which helps break the air boundary layer around foods being cooked and thus speeds hot air heat transfer to foods. Cooking speed is also increased because foods are alternately super-heated on their surfaces as they pass directly in front of the heating element 32 and then the heat is allowed to soak into the foods as they rotate away from the heating element 32.

Kabobs Function

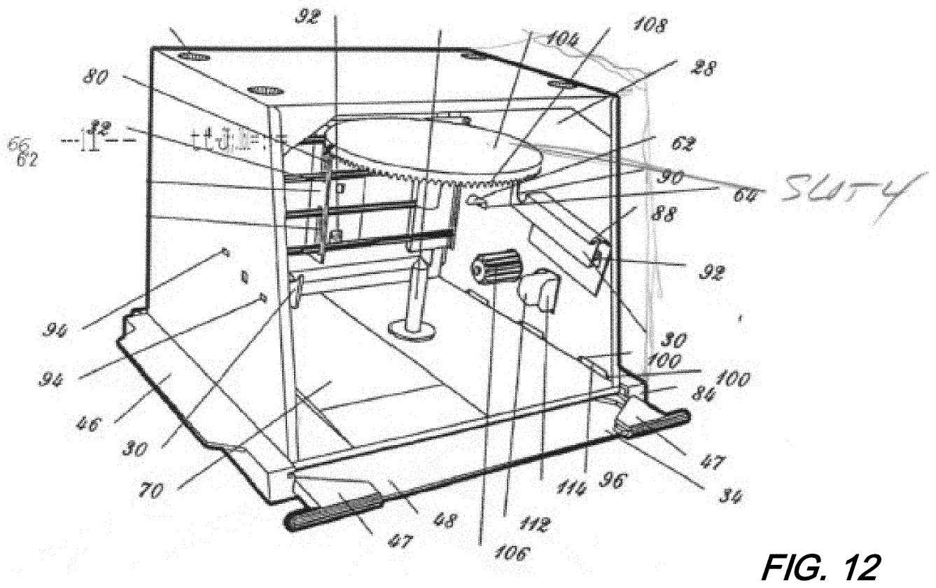

As depicted in FIG. 10, both the first 172 and the second spit plates 174 each have eight evenly spaced kabob holes 182 penetrating their structure just inside their perimeter gear teeth 180. These holes 182 are designed to hold the ends of self-rotating kabob rods 184. Each kabob hole 182 is essentially circular hole passing through the spit plate 172 and 174 with four evenly spaced semicircular lobes carved into its perimeter.

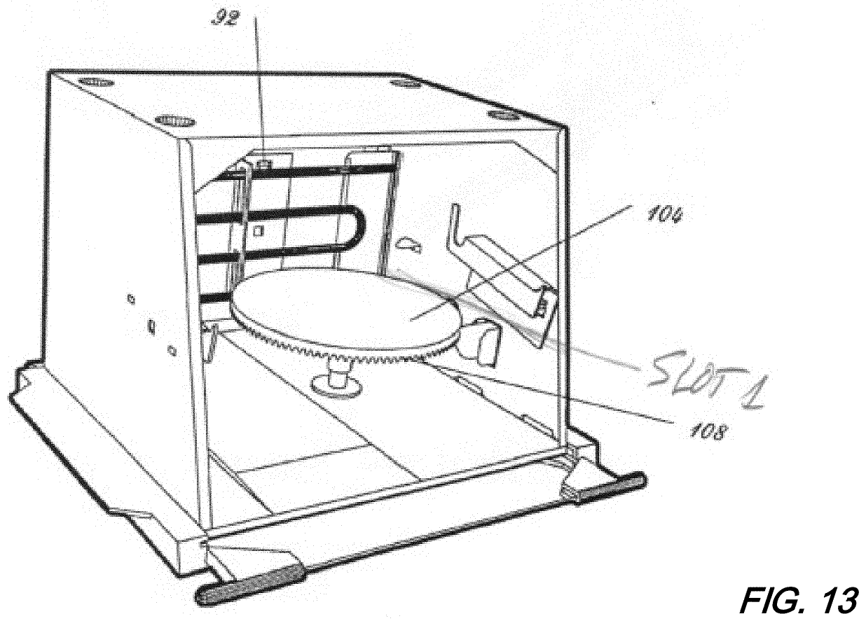

As depicted in FIG. 11, engaging these kabob holes 182 are self-rotating kabob rods 184. Each kabob rod 184 has a pointed end 216, and an end with a drive cam 218 and retaining spring 220. The kabob rods 184 work by the spit assembly 170 first being put together with the spit rod holding tubes 192 on the second spit plate 174 being pushed over the pointed ends of the two spit rods 176 and 178 projecting from the first spit plate 172.

Each kabob rod 184 to be used is then loaded with food by skewering the food onto the kabob rod 184 using its pointed end 216. Any number of kabob rods 184 may be used at any one time, from one up to the spit assembly's 170 capacity of eight.

To insert a kabob rod 184 onto the spit assembly 170, the pointed end 216 of the kabob rod 184 is inserted through a kabob hole 182 in the spit plate 172 and 174 which will be closest to the inner panel 103 of double paneled left wall 30. Then the rod 184 is backed into an opposing hole 182 in the other spit plate 172 and 174 where the retaining spring 220, as its widest 183 part passes through the kabob hole, snaps and retains the kabob rod 184 from side to side movement away from or toward either spit plate 172 and 174 like the way a clothing snap works. This insertion process is easy and intuitive and is repeated for each kabob rod 184 to be used.

Insertion of the kabob rods 184 onto the spit assembly 170 may be done while the spit assembly 170 is outside of the enclosure 20 or while it is placed in a track position inside the enclosure 20, such, as an example, as being placed in the rest axle positioning indent position 168. The spit assembly 170 with attached kabob rods 184 is then inserted into the normal rotisserie axle positioning indent position 122, and the embodiment turned on by setting the cooking time on the digital timer 222.

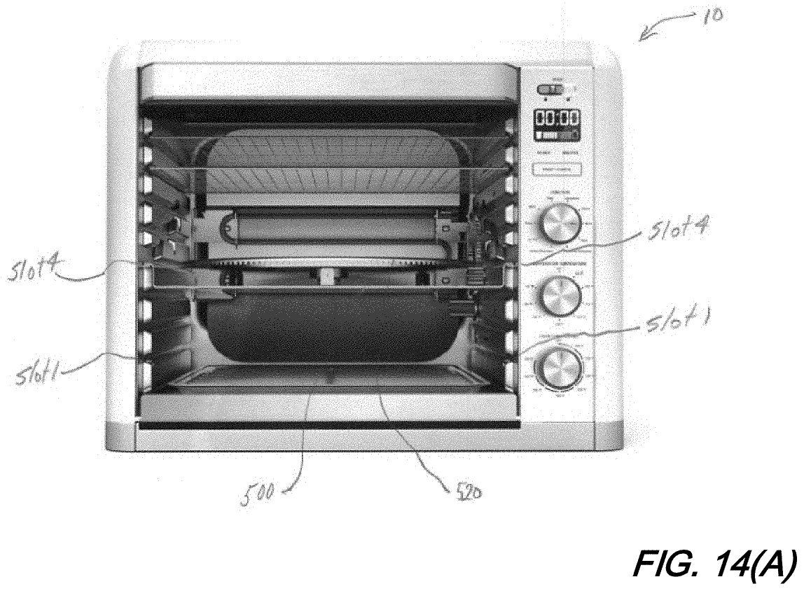

As depicted in FIG. 12, each 360 degree rotation 175 of the spit assembly 170 causes each kabob rod 184 to be rotated 177 one-quarter turn by the kabob rod's 184 drive cam 218 being rotated by the spit plate 172, 174 into the drive gear 208, which forces one of the kabob rod's cam 218 arms striking the drive gear 208 to move and consequently causes the one-quarter turn rotation of the kabob rod 184.

The four lobes 214 in each of the spit plate 172 and 174 kabob holes 182 help stop each kabob rod 184 at even one-quarter turn intervals and help prevent a kabob rod 184 from rotating in its kabob hole 182 when it is not being driven by the drive gear 208 pushing on the kabob rod cam 218. This kabob rod 184 automatic rotation results in all sides of the kabob rod cooked food being cooked evenly, unlike in most rotisserie kabob cooking where one side of the kabob food gets cooked more than the opposite side.

The kabob rods 184 of one or more preferred embodiments are better than others commonly available for several reasons. First, they 184 may automatically rotate, as explained above, which cooks kabob foods more evenly on all sides than non-rotating rods. Second, one, or up to the spit wheel's capacity of eight kabob rods, can be in use at any time. Some kabob rods require the entire transport wheel to be loaded with kabob rods to operate. Third, the rods 184 can be inserted or removed while the rods 184 are inside the cooking cavity 28. Many kabob rods require a lot of space to be inserted or removed from their transport wheel, and thus they could not be inserted and removed from inside a confined cooking space.

Next, the rods 184 are very efficient in space utilization and allow foods to be placed along most of the rod's 184 entire length. Along with this, the rod's 184 means of attaching to their transport wheels 172 and 174 is compact and therefor allows more room for cooking foods with less wasted space for attachment to the transport wheels 172 and 174. Many kabob rods use a substantial portion of their length for coupling which limits their cooking space. And the kabob rods 184 intuitively snap into place which makes them easy to use. This also generally removes the need for user instructions. Many kabob rods have complicated coupling mechanisms which are both difficult to use and require detailed user instructions.

The rods 184 offer the ability for each rod 184 to automatically rotate or remain stationary at the user's discretion and in any combination (i.e. 3 rotating and 2 remaining stationary all simultaneously) simply by the user facing the rod's cam 218 toward or away from the drive gear 208 side of the cooking cavity 28. This feature is not found on other kabob rod designs. And when the rods 184 are stationary, bacon, slabs of baby back ribs or other foods may be wrapped around and clipped to the rods in drum-like fashion for fast even cooking.

Vertical Rotisserie Function

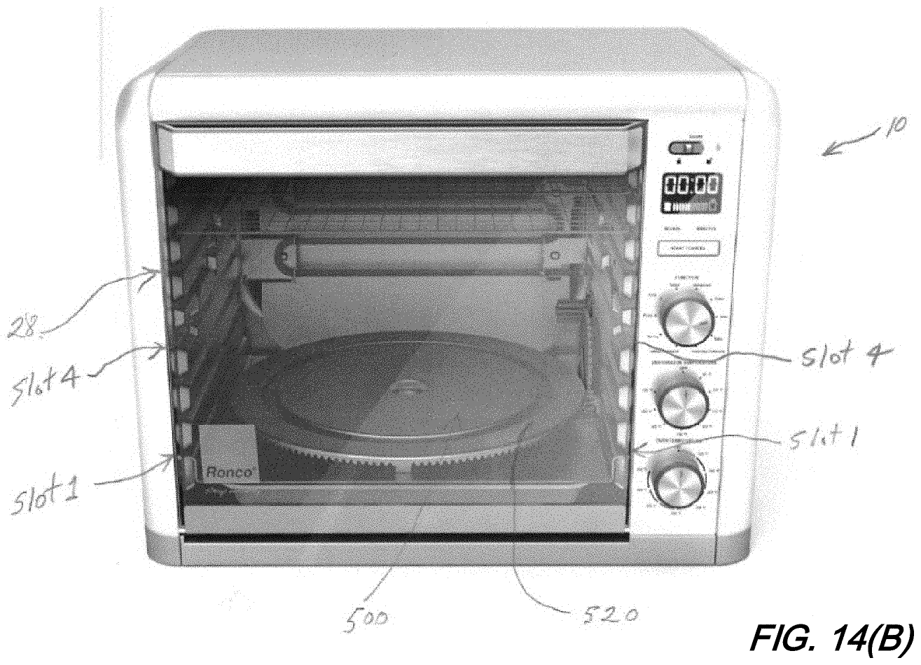

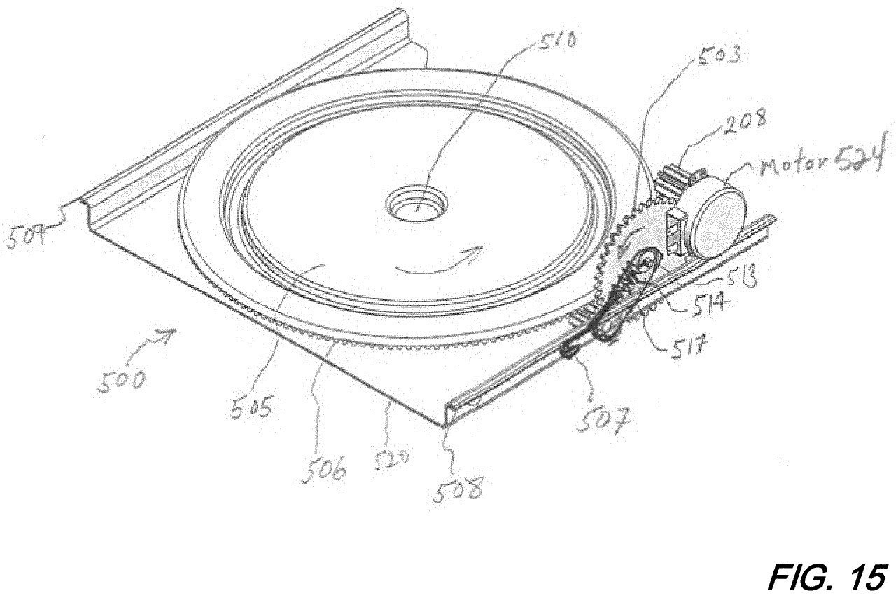

FIG. 12 and FIG. 13 illustrate the installation of vertical axis turntable assembly 500 within oven cavity 28. Turntable 505 is supported by a metal tray 520 that can be slid into at least two different oven vertical positions. As illustrated in FIG. 12, FIG. 13, FIG. 14(A), and FIG. 14(B), turntable 505 is mounted in the lowest and mid-areas of cavity 28, respectively. For example, when multi-function cooking oven 10 is operating as a baking oven, vertical axis turntable assembly 500 slides in the bottom row of tray slots into slot 1. And a further example, in FIG. 14(A) when multi-function cooking oven 500 is operating to cook pizza, vertical axis turntable assembly 500 slides in the middle row of tray slots into slot 4.

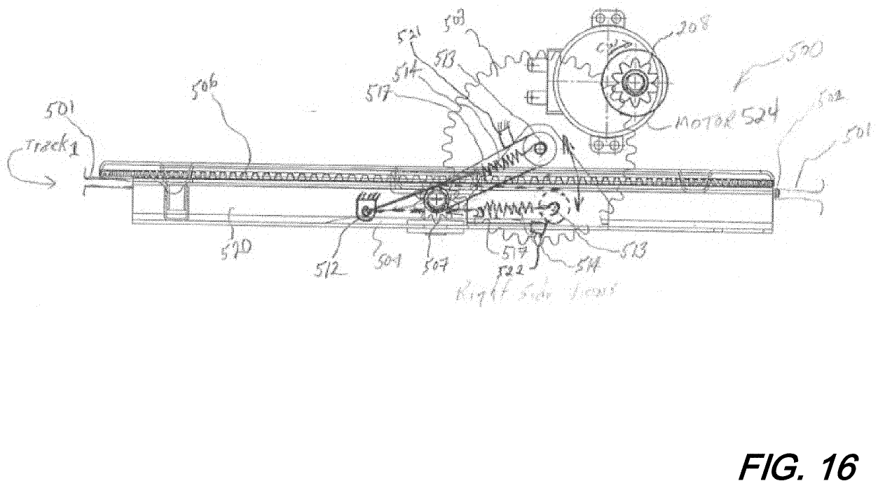

FIG. 15 shows a isometric view of a vertical axis turntable assembly 500 to be loaded within oven cavity 28 to provide rotation of food along a vertical axis. Turntable 505 is supported by a metal tray 520 that can be slid into at least two different oven vertical positions, but in at least one preferred embodiment it can be loaded into four oven vertical positions. FIG. 13 and FIG. 14(B) show vertical axis turntable assembly 500 loaded into the lowest or bottom tray slot 1. This lower position tray slot 1 within multi-function cooking oven 500 is desirable when baking meats or farinaceous foods, for example. FIG. 11 and FIG. 14(A) show vertical axis turntable assembly 500 loaded into the middle tray slot 4. This middle position tray slot for within multifunction cooking oven 500 is a desirable position when baking or heating pizza and other breaded foods. This puts the pizza closer to the two heating elements 420 near the top of the oven cavity 28 so browning will occur.

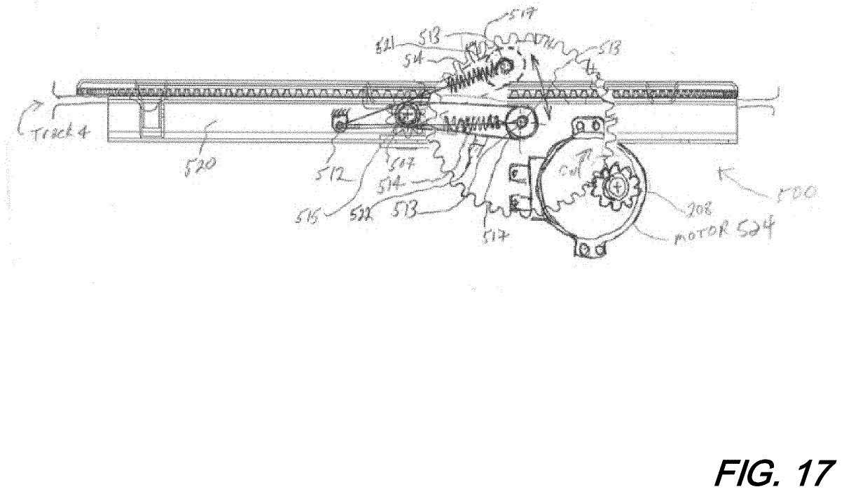

Since the motor pinion drive gear 208 is in a fixed position, the idler gear 503 adjusts to engage gear 208 when vertical axis turntable assembly 500 is mounted in either tray slot 1 or tray slot 4. As best depicted in FIG. 16, when the vertical axis turntable assembly 500 is inserted into lower slot 1 and slid to the rear to be fully mounted, the turntable assembly gear 503 automatically engages the motor pinion gear 208. When gear 208 is driven to rotate along its axis, it turns the engaged idler gear 503, which in turn rotates gear 507 mounted to the turntable assembly 500. Gear 507 engages the perimeter gear teeth 506 on the bottom of the turntable 505, which is vertically and rotationally supported by three roller assemblies 509, 510 and 511.

When motor 524 is electrically engaged, it rotationally drives motor pinion gear 208 to rotationally drive idler gear 503 and in turn drive gear 507 to finally drive rotation of turntable 505 through engagement with perimeter gear teeth 506, thereby rotating turntable 505. With food placed on turntable 505, it is rotated in front of heating element 32 providing vertical axis rotisserie cooking.

FIG. 16 shows a right-hand view of vertical axis turntable assembly 500 when loaded into tray slot 1. Idler gear 503 is shown in proper engagement with motor gear 208 for lower tray slot 1. Arm 517 is rotatably engaged about the axis of drive gear 507 at one end and about the axis of idler gear 503 at the other. Extension spring 514 is connected at one end at pin 513, which extends out from the axis of idler gear 503, and at its other end at fixed stud 512. Extension spring 514 places a counterclockwise torque on arm 517, thereby holding arm 517 against fixed stop 521. As the motor 524 rotates gear 208 clockwise, idler gear 503 is rotated counterclockwise, and in turn rotates gear 507 clockwise, in turn rotating perimeter gear 506 of turntable 505.

FIG. 16 shows a right-hand view of vertical axis turntable assembly 500 when loaded into tray slot 4. When vertical access turntable assembly 500 is moved from tray slot 1 to tray slot 4, an angled fixed member (not shown) on slot 4 engages pin 513 to apply downward pressure on arm 517 against the resistance of spring 514. Alternatively, the operator can push down on gear 503 and or arm 517, causing arm 517 to rotate about the axis of gear 507 until it engages in the stop at stop 522.

In this position, idler gear 503 is in proper engagement with motor gear 208 such that gear teeth of idler gear 503 is engaged with gear teeth of motor gear 208. Extension spring 514 is connected at pin 513 and at fixed stud 512 placing a clockwise torque on arm 717 holding it against fixed stop 522. As the motor rotates gear 208 clockwise, idler gear 503 rotates counterclockwise, in turn rotating gear 507 clockwise and driving perimeter gear to rotate turntable 505 clockwise. As an alternative, turntable 505 can be powered by its own dedicated motor which could either be installed under turntable frame 520 on vertical axis turntable assembly 500 or in multi-function cooking oven 500.

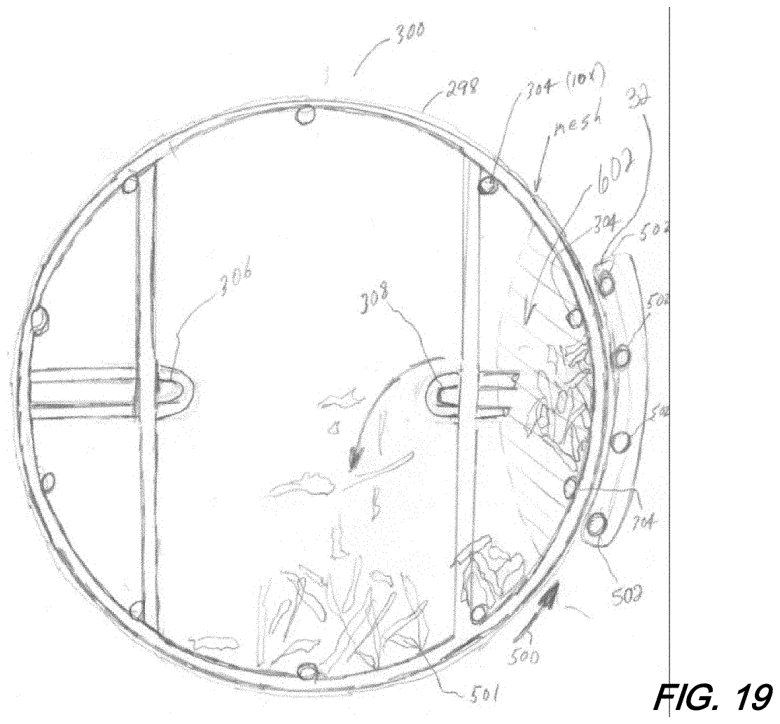

FIG. 18 is an image of multi-function cooking oven configured for the vertical rotisserie function with chicken and vegetables placed on the vertical axis turntable assembly 500. Also, meats used in making Greek Euros are typically cooked on a vertical rotisserie.

Control panel 37 is set to the vertical rotisserie function, setting the turntable 505 in rotation and heating element 32 set on full power. In some preferred embodiments, control panel 37 sets a timer within enclosure 36 based on the vertical rotisserie function to turn off heating element 32 after the appropriate amount of cooking time to roast a chicken with heating element 32 set on high.

As already mentioned, several different foods may be cooked on vertical axis turntable assembly 500. As examples, and not by way of any limitation, pizzas, cookies, cake layers, and hors d'oeuvres may all be cooked as well as many others known to those in the art. The French crepes may be cooked directly on the flat upper surface of turntable 505 in a manner similar to making American pancakes, turntable 505 may be used to cook the crapes, perhaps in the traditional French manner as known to those of the art.

Air Fryer Function

The Air Fryer function uses a drum-shaped rotary container which stirs, fries and rotary cooks foods such as french fries, meats, popcorn, shrimp, peanuts, coffee beans, etc. As shown in FIG. 10, the air fryer comprises a spit assembly 170 with a mounted cylindrical housing 300 with at least one opening on one end, such opening 302 which may be covered by a lid or door when cooking. Several agitation blades 304 project from the interior surfaces of the cylindrical housing 300 and help move and direct food inside the housing 300 while the housing 300 is being rotated.

The spit plate's 172 and 174 large outer diameter gear 180 greatly reduces the play and backlash in the motor speed reduction gear drive train caused when off-center weighted foods are rotated. In this situation the motor pushes off-center foods uphill until the off-center weight swings over the top of center and then moves downhill constrained by the drag of the motor. The shift from the motor pulling the food uphill to the motor constraining the food's movement downhill causes a shock load on all the gears in the gear reduction train, and particularly on the final drive gears, as any free movement, or play, between the gears in the gear train shifts with the full power of the off-center weighted foods behind it.

As shown in FIG. 10, in use, the cylindrical housing 300 is mounted onto the spit rods 176 and 178 through holes in the housing's ends 306, 308. A shape other than cylindrical may be used for the tubular housing 300 of the rotary cooking container 298. As examples, the tubular housing might be square, pentagonal, hexagonal, irregular, or other shape in cross section.

Typical final drive gears found in rotisserie drive trains are one-tenth or less of the diameter of the spit plate's outer gear teeth 180 and thus generally are far less durable, have far more play, and put far more load on both the spit and attached food, and on the rest of the reduction drive gear train itself. This in turn may result in shorter motor and gear life, food disengaging from and falling off of the spit rod, and unacceptable levels of noise and vibration.

To use the multi-function cooking oven 10 as an air fryer, the user mounts the tubular housing 300 with food on the spit rods 176 178, possibly sprayed with cooking oil, spices, etc., or placed inside the housing 300 through the hole 302 or holes 302 in the ends 306 308 of the housing 300, caps the housing 300, if a cap or door is to be used, and places the spit assembly 170, including the rotary cooking container 298 with its food contents, into the high heat axle positioning indent position 202 spit mounting position inside the enclosure 20.

FIG. 2 shows a left side section view of an embodiment shown in FIG. 1 of multifunction cooking oven 10, and FIG. 3 is a perspective view of the section shown in FIG. 3. Inserting the spit assembly 170 into the multi-function cooking oven 10 begins with resting it on the left and right spit support tracks 200 and 198 and lifting and pushing it back into the enclosure 20 to the desired use axle positioning indent position 168, 122 and 202, be it the rest axle positioning indent position 168, the normal rotisserie axle positioning indent position 122 or the Air Fryer axle positioning indent position 202. Removing the spit assembly 170 from the Air Fryer axle positioning indent position 202, the normal rotisserie track axle positioning indent position 122, or from the rest track axle positioning indent position 168, requires only lifting and pulling the spit assembly 170 toward the front of the enclosure 20. This easy insertion of the spit assembly 170 into, and simple removal of the spit assembly 170 from, the embodiment enclosure 20 is in marked contrast to most other rotisseries which typically require angling the spit rod assembly into its cooking position and carefully fitting one of the spit assembly's ends into a drive socket. Use of the relatively large diameter spit plates 172 and 174 as the final reduction gear in the motor rotational speed reducing gear train driving the spit assembly 170 has several advantages when compared with typical rotisserie drives which use a gear box terminated by a drive socket directly coupled to the spit rod.

The speed reduction between the drive gear 208 and the gear teeth 180 on the spit plate 172 and 174 is ten-to-one in the preferred embodiment but may be greater or less depending on the desired diameter of the spit plate and the coarseness needed in the gear teeth. In the preferred embodiment, such a high gear reduction outside of the gear transmission 210 attached to the gear reduced motor 212 means that fewer and less durable, which may translate to less expensive, gears may be used inside the gear transmission 210 attached to the gear reduced motor 212. And by eliminating the drive socket which is generally used to attach the spit assembly to the final drive gear of the motor speed reducing gear transmission, any play in the socket engagement with the spit assembly or any binding in inserting or removing the spit assembly into and from the drive socket are eliminated.

As best seen in FIG. 2 and FIG. 3, directly behind and above the normal rotisserie track axle positioning indent position 122, is the Air Fryer axle positioning indent position 202. Again, the stub axles 186 of the spit assembly 170 may be pushed back, raised and rested into this position. In this position the gear teeth 180 in the perimeter of the spit plate closest to the right side inner side wall 101 may engage the drive gear 208 and the spit assembly 170 may be thus power rotated. Smaller foods may be rotated closer to the heating element coils 502 in the Air Fryer axle positioning indent position 202 which may greatly reduce such smaller foods' cooking times.

The Air Fryer function requires housing 300 with the rotary cooking container 298 to be placed in oven cavity 28, with axle 186 of the spit rod assembly 170 being mounted in the superheat axle positioning indent position 202. When housing 300 is properly placed in this Air Fryer position, an air passage to a superheated zone is automatically opened and a fan forces a stream of air through the superheated zone in container 298 to air fry foods, such as French fries, for example, loaded into the mesh drum for cooking.

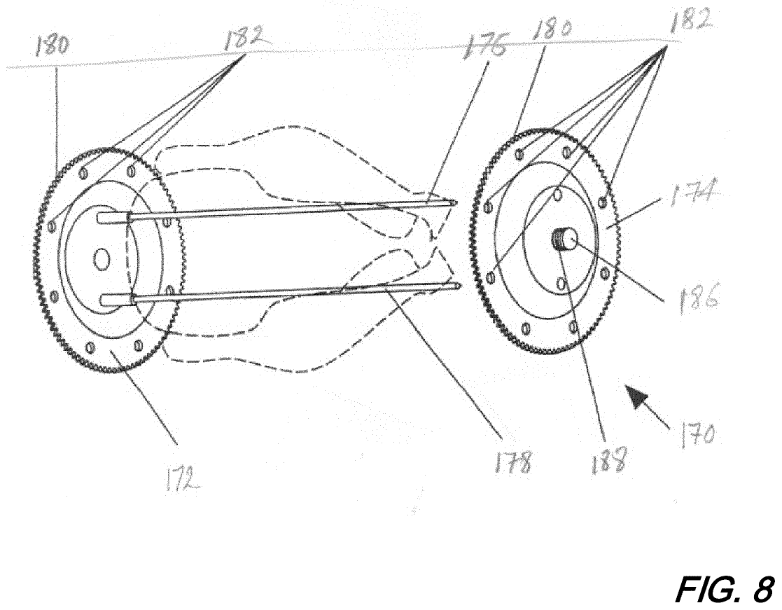

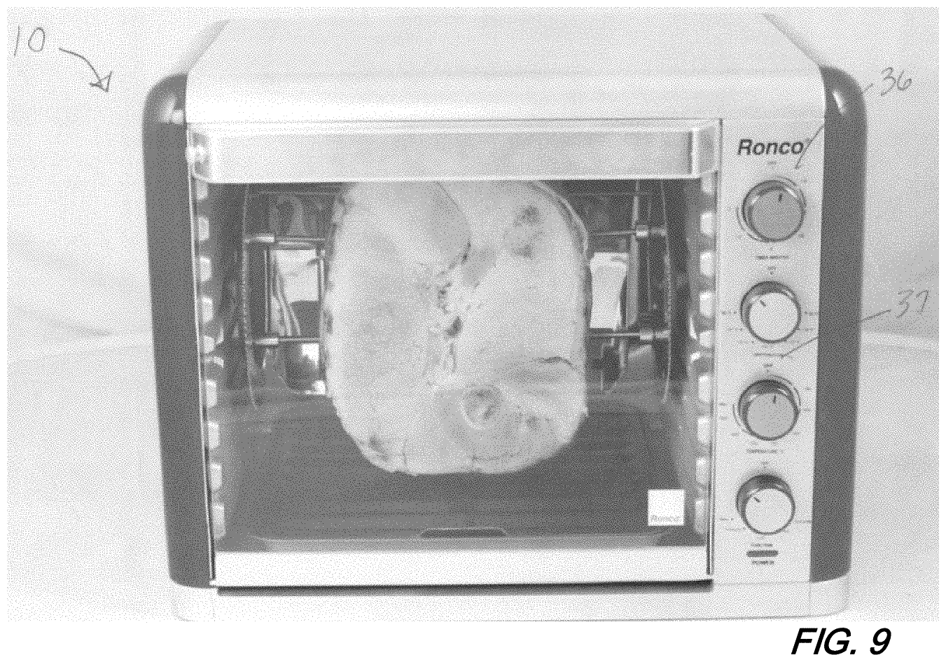

As seen in FIG. 5, FIG. 6 and FIG. 7, a fan 258 provides air flow heating of food in oven 10 by circulating hot air within the cavity 28 and increasing cooking temperatures by recirculating hot air through the superheated zone when in the Air Fryer oven function. Fan 258 is electrically engaged under command of control panel 37 and pulls air from within enclosure 36 into oven cavity 28 through air inlets 424 and into airflow 426. Airflow 426 within oven cavity 28 moves air past both the heating coils 502 of heating element 32 and the heating elements 420 and is heated to, in some embodiments, 600 degrees Fahrenheit. Airflow 426 carries the air under force of fan 258 throughout oven cavity 28, where it is continuously recirculated past heating element 32, and in some oven functions, heating elements 420 to be continuously heated. Food within oven cavity 28 is continuously cooked by the recirculating heated air. In some embodiments, control panel 37 maintains the temperature within oven cavity 28 by controlling fan 258, heating element 32 and heating elements 420. In other embodiments, control panel 37 turns on heating element 32, 420 and controls cooking based on time by turning off heating elements 32, 420 at the end of the predetermined cooking function time as determined by the timer 518. Further, air outlets 428 allow some escape of heated air within the oven cavity 28. For the Air Fryer function, fan 258 recirculates air through the entire oven but specifically in the superheat zone.

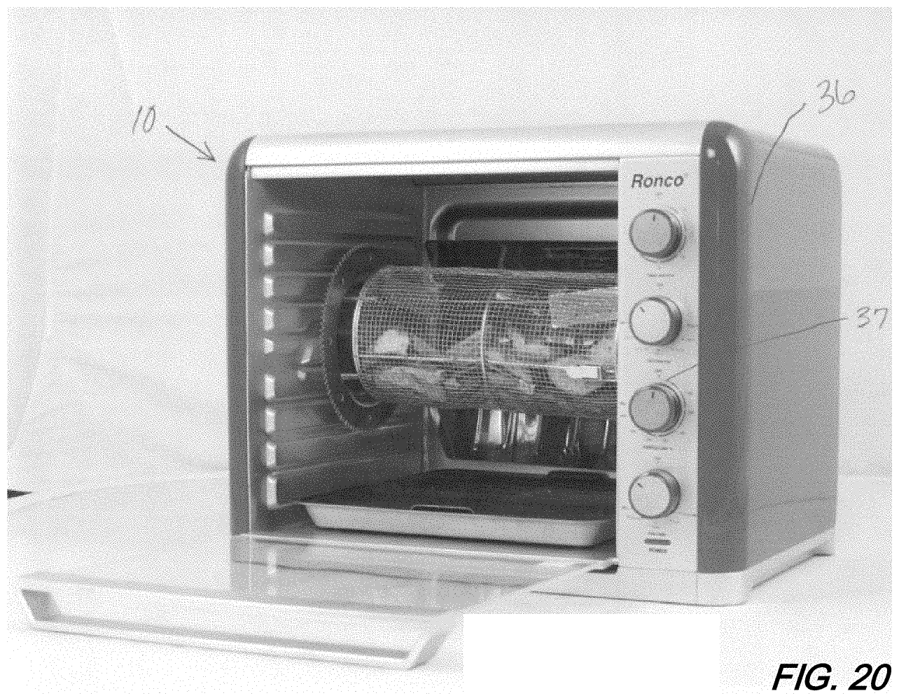

As seen in FIG. 19, spit rod assembly 170 rotates container 298, agitation blades 304 inside the drum lift a portion of the food up to the superheated zone 602 near the heating element 32. Here the cooking speed is dramatically increased because the foods are elevated by a rotating mesh drum to a superheated zone where they almost touch the heating rods 502 of heating element 32.

In some preferred embodiments, agitation blades 304 are the frame of the container 298 and comprise ten steel rods equally and axially spaced and are on the inside mesh outer cover. In some preferred embodiments, these rods lift the food up within 5 mm of the heating rods 502 in heating element 32. For some preferred embodiments, the temperature in this superheated zone 602 approaches 700 degrees Fahrenheit. The airflow 426 within the superheated the 602 is also superheated and further enhances the air frying of the food.

While in this superheated zone 602, the food is superheated on its surfaces, and then the food quickly tumbles back down to the bottom of the drum housing 300 to lower temperature space at the bottom of the drum housing 300. To enhance and increase the air frying effect, air is blown throughout the space and with special emphasis this superheated zone area adding to the dehydration and crisping of the food. As the container 298 continues to rotate, the food is continuously lifted back up to the superheated cooking zone 602 and then drops off the agitation rods to stir and mix as it tumbles back to the lower-temperature container bottom.

The rotary cooking container shown in FIG. 19 adds a convenient cooking feature of automatically agitating foods without user intervention. When cooking, this means that foods tend not to burn and may be cooked with little or no oil or fats. Either rotary cooking container may be nonstick coated on their interiors to help facilitate not using fats and oils during cooking. Such coatings are well known in the art and thus are not described in detail herein.

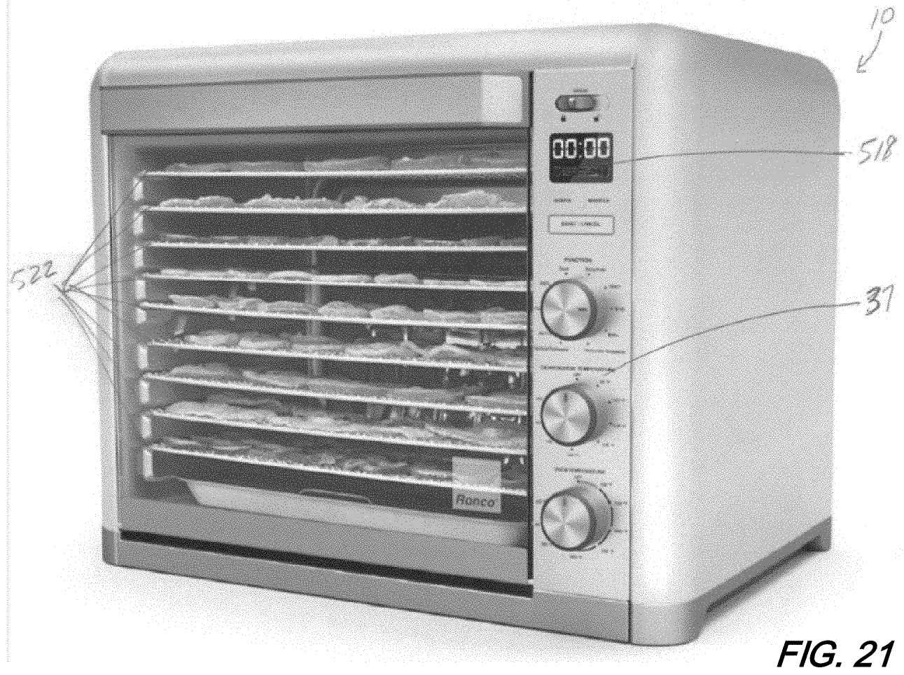

FIG. 20 shows an image of multi-function cooking oven operating in the air fryer function. Control panel 37 is set to the air fryer function. This turns on heating elements 32, 420, turns on fan 258, engages motor 524 to rotate turntable 505, and sets the timer in enclosure 36 to proper air fry food in the air fryer function. Upon expiration of the timer, control panel 37 turns off heating element 32,420.

Dehydrator Function

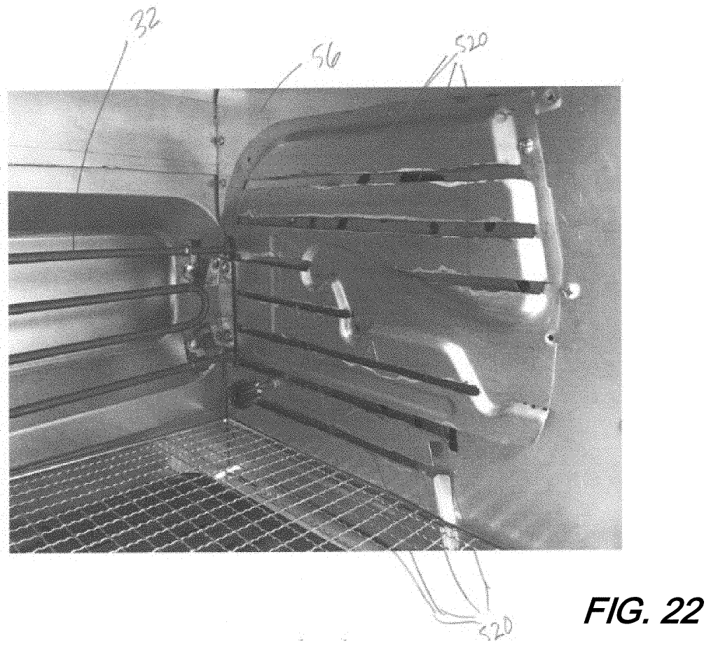

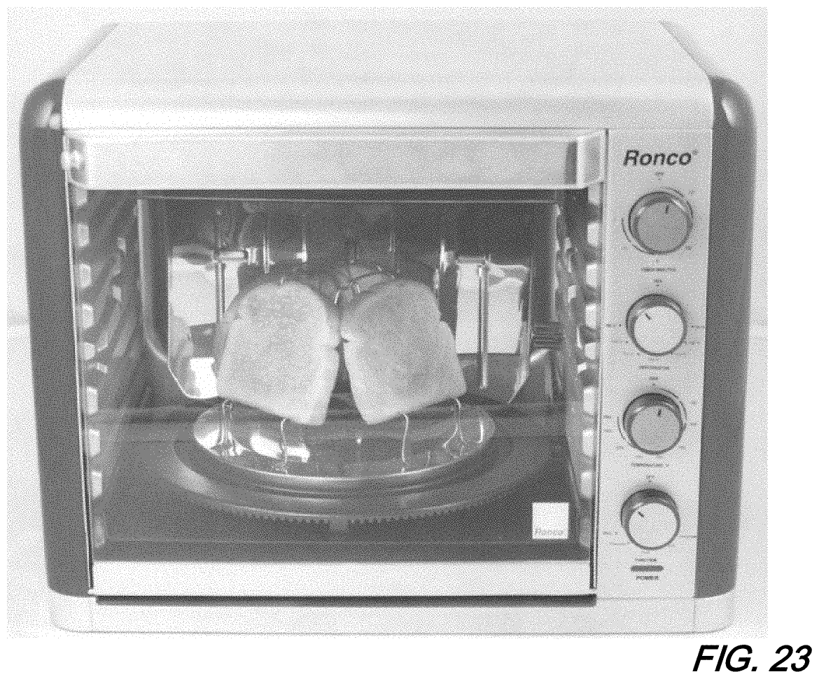

FIG. 21 shows an image of the multi-function cooking oven operating as a dehydrator. Multi-function cooking oven 10 is set to the dehydrator function on control panel 37, which sets the heating elements 32 to a lower temperature setting than the full power heating. Control panel 37 also sets a timer 518 on control panel 37 to properly dehydrate food while in this dehydrator function mode. FIG. 22 is an image of the inside cavity 28 of multi-function cooking oven 10 showing the white bright side wall 56 and multiple tray slots 524 holding multiple trays 522 for placing food for dehydration.

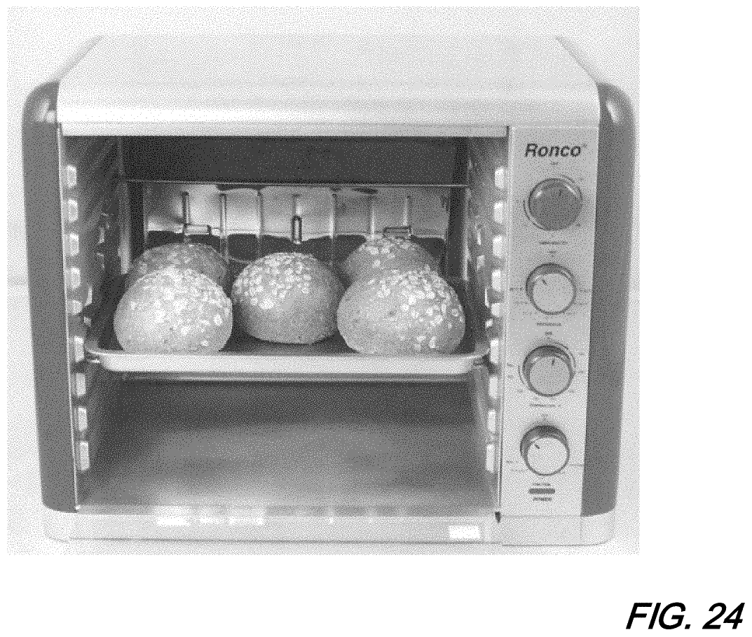

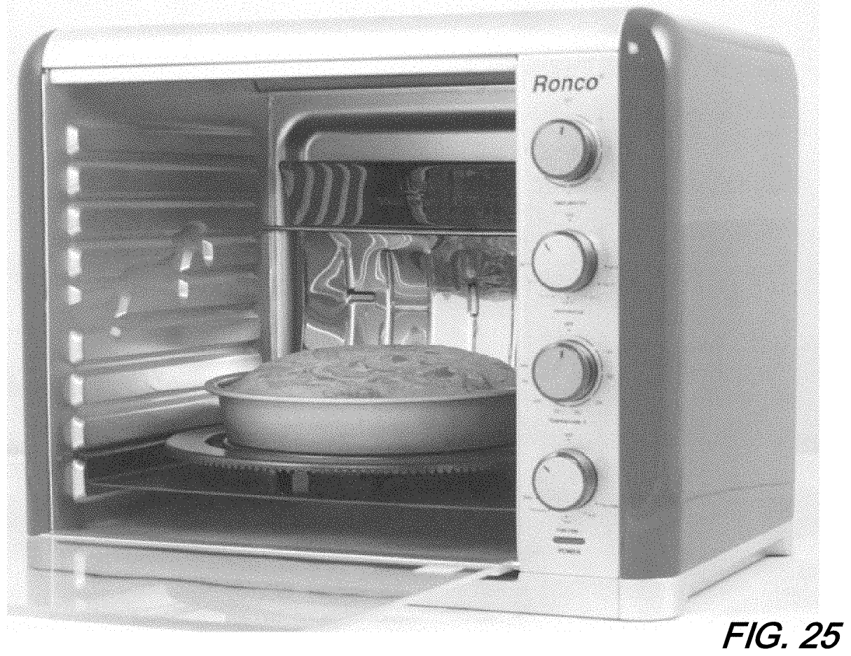

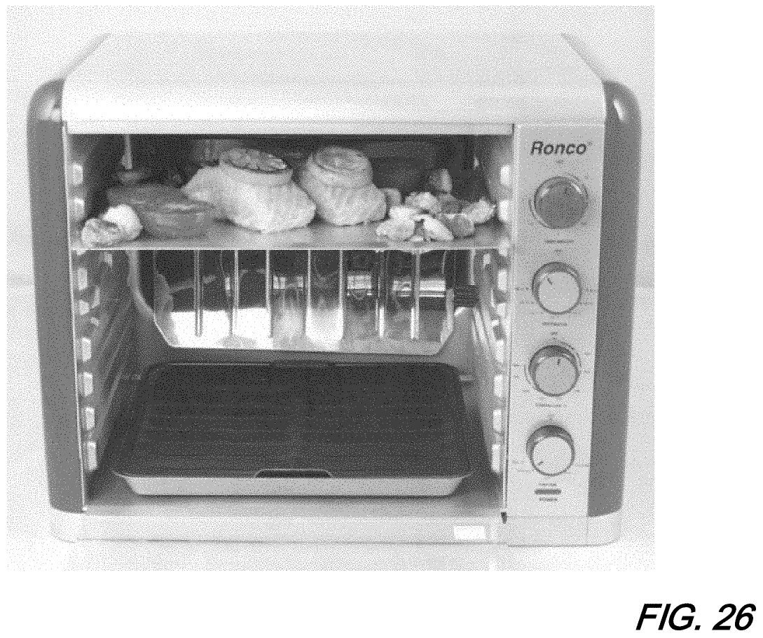

As already mentioned, several different functions of the multi-function cooking oven can be implemented using the trays 522 and heating element 32 by a setting the appropriate function on control panel 37. As examples, and not by way of any limitation, pizzas, cookies, cake layers, and hors d'oeuvres may all be cooked as well as many others known to those in the art. As further examples, and not by way of any limitation, as shown in FIG. 23, toast can be toasted, or American pancakes and flapjacks can be cooked. As further examples, and not by way of any limitation, as shown in FIG. 24, food can be warmed, and, as shown in FIG. 25, food can be baked, and, as shown in FIG. 26, food can be broiled.

Descriptions of the embodiments are to be taken and/or construed as illustrative and/or exemplary only and are for teaching those skilled in the art the general manner of carrying out the methods, processes, and/or systems described herein. These embodiments are described in order to explain the principles of the disclosure and one or more implementations and/or one or more applications to enable those in the art to understand the disclosure and practice various embodiments thereof with various modifications as may be suited to their particular use contemplated.

At this point, while we have presented this disclosure using some specific examples, those skilled in the art will recognize that our teachings are not so limited. Accordingly, this disclosure should be only limited by the scope of the claims attached hereto.

1. A device for cooking food comprising:
an enclosure;
a cooking heat source disposed in the enclosure;
a generally tubular container capable of being supported in the enclosure so that the container can rotate about a horizontal axis within the enclosure;
a fan operable to provide recirculating air in the enclosure, said fan configured to provide a superheated zone within the enclosure;
such that food located in the rotating tubular container will be moved into the superheated zone through the effect of the rotating tubular container;

2. The device of claim 1 wherein said tubular container exhibits a cross-sectional shape selected from the group consisting of: square, pentagonal, hexagonal, irregular, and circular.

3. The device of claim 1 wherein said tubular container includes a plurality of agitation blades axially placed on an inside portion of the tubular container such that the food in the rotating tubular container is agitated.

4. The device of claim 1 wherein said food repeatedly moves into and out of the superheated zone through the effect of the rotating tubular container.

5. The device of claim 1 wherein the heat source includes a horizontally oriented heat source and a vertically oriented heat source and the superheated zone is generated by the fan recirculating air over both of the horizontal and vertical heat sources.

6. A device for rotationally cooking food comprising;
an enclosure;
a cooking heat source disposed in the enclosure;
a rotatable food support structure removably disposed within the enclosure and positioned a distance from the heating element, said rotatable food structure being one selected from the group consisting of:
a horizontal rotatable food support structure having gear teeth and a substantially horizontal rotational axis such that food is rotated about that horizontal axis when the horizontal food support structure is rotated; and
a vertical rotatable food support structure having gear teeth and a substantially vertical rotational axis such that food is rotated about that vertical axis when the vertical food support structure is rotated;
a drive gear positioned on a side wall of the enclosure, said drive gear configured to engage with the gear teeth of the rotatable food support structure when such structure is removably disposed therein.

7. The device according to claim 6 wherein the horizontal rotatable food support structure is one selected from the group consisting of: a horizontal spit assembly, and a cooking basket.

8. The device according to claim 6 wherein the vertical rotatable food support structure is one selected from the group consisting of: a turntable, and a vertical spit assembly.

9. The device according to claim 6 wherein the cooking heat source comprises one or more vertically oriented heating element(s) and one or more horizontally oriented heating elements.

10. The device according to claim 9 further comprising a fan that circulates air within the enclosure thereby creating convection currents.

11. The device according to claim 10 wherein the convection currents simultaneously establish a superheated zone within the enclosure that is substantially hotter than other, non-superheated zone(s) within the enclosure.

12. The device according to claim 1 wherein the horizontal rotatable food support is further height adjustable.

13. The device according to claim 2 wherein the horizontal spit assembly including first and second spit rods that extend between first and second opposed end plates, and an even-number of removable kebab rods extending between the first and second end plates, the kebab rods capable of holding food for cooking.
